(19) United States
(12) Patent Application Publication
(10) Pub. No.: US 2005/0195751 A1
(43) Pub. Date: Sep. 8, 2005

(54) System and method for identifying devices using a point to point protocol

(75) Inventors: Kenneth Roger Jones, Cool, CA (US); Brian A. Gonsalves, Antioch, CA (US); Zesen Chen, Pleasanton, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/791,359

(22) Filed: Mar. 2, 2004

(51) Int. Cl. H04L 12/28

(52) U.S. Cl. 370/254

(57) ABSTRACT

A system and method are disclosed for indicating network connectivity and access to an information service offering. A method incorporating teachings of the present disclosure may include receiving at a router a request to establish a Point to Point Protocol over Ethernet (PPPoE) session for a LAN-side device. The LAN-side device may be acting or capable of acting as a LAN node and may be “sharing” a broadband backhaul accessible via the router. In response to receiving the request to establish a PPPoE session, a PPPoE discovery stage packet may be output and may contain a tag identifying and/or assigned to the LAN side device. Similarly, if a different LAN-side device desires a PPPoE session, a request packet to establish a different PPPoE session may be received, and another PPPoE discovery stage packet including a different tag may be output.

### FIELD OF THE INVENTION

The present disclosure relates generally to accessing an information network, and more specifically to a system and method for identifying connected devices using a point to point protocol.

### BACKGROUND

A network may be characterized by several factors like who can use the network, the type of traffic the network carries, the medium carrying the traffic, the typical nature of the network's connections, and the transmission technology the network uses. For example, one network may be public and carry circuit switched voice traffic while another may be private and carry packet switched data traffic. Whatever the make-up, most networks facilitate the communication of information between at least two nodes, and as such act as communication networks.

At a physical level, a communication network may include a series of nodes interconnected by communication paths. One or more of these nodes may act as an aggregation point. Several devices and/or nodes may connect to the aggregation point and “share” the aggregation point's backhaul connection. Depending on implementation detail, the aggregation point may “hide” the identity of the devices sharing its connection. While allowing these devices to hide may be advantageous in some circumstances, it may also create several difficulties for entities attempting to provide trouble-shooting and/or make network-planning decisions for the hidden devices.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for a process that facilitates identification of Local Area Network (LAN) side devices using a Point to Point Protocol in accordance with the teachings of the present disclosure; and

FIG. 2 shows one embodiment of a distributed system that incorporates teachings of the present disclosure to identify and support LAN-side devices.

### DETAILED DESCRIPTION OF THE DRAWINGS

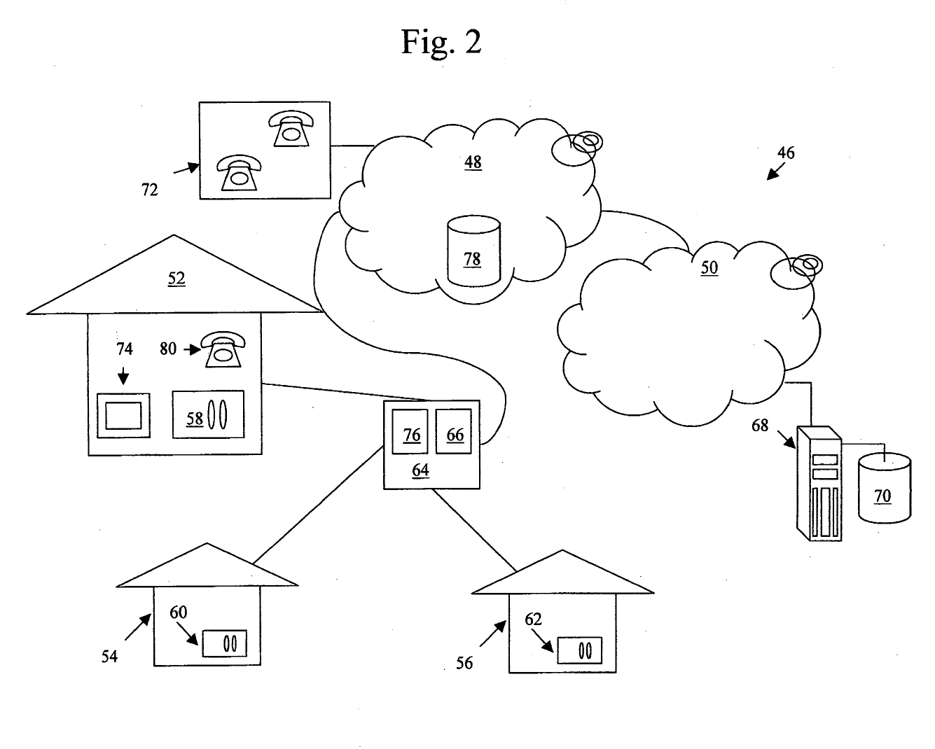

Embodiments discussed below describe, in part, identifying network connected devices using Point to Point Protocol over Ethernet (PPPoE). Though much of the following discussion focuses on router-type devices interconnecting Local Area Network (LAN) resources and Wide Area Network (WAN) nodes, the teachings disclosed herein may have broader applicability. In addition, though the specific embodiment described in connection with FIG. 2 details a Digital Subscriber Line (DSL) broadband system utilizing distributed PPPoE clients, systems based on other networking technologies and clients may be implemented to incorporate the teachings disclosed herein.

From a high level, a system like the one depicted in FIG. 2 may include a device or collection of devices capable of performing router like functions. This device or collection of devices may be referred to as a router, aggregation point, router-like device, and/or some other appropriate name and may include other capabilities such as modem capabilities and processing capabilities. A router and/or other component may bridge or interconnect a LAN with a WAN, Metropolitan Area Network (MAN), or other network. In effect, the router-like device may represent a point of demarcation between the LAN and a broader network connected to the LAN at the point of demarcation.

A method incorporating teachings of the present disclosure may include receiving at a router a request to establish a Point to Point Protocol over Ethernet (PPPoE) session for a LAN-side device. The LAN-side device may be acting or capable of acting as a LAN node and may be “sharing” a broadband backhaul accessible via the router. In response to receiving the request to establish a PPPoE session, a PPPoE discovery stage packet may be output and may contain a tag identifying and/or assigned to the LAN side device. Similarly, if a different LAN-side device desires a PPPoE session, a request packet to establish a different PPPoE session may be received, and another PPPoE discovery stage packet including a different tag may be output.

In practice, PPPoE may be seen as having two distinct stages, a Discovery Stage and a PPP Session Stage. When a LAN-side device wishes to initiate a PPPoE session, the device may initiate performance of the discovery stage to identify an Ethernet MAC address of a peer, to establish a PPPoE SESSION_ID, and/or to accomplish some other objective. While PPPoE is a peer to peer protocol, PPPoE discovery may be viewed as a client-server type relationship in which a requesting device and a network node exchange packets of information.

The discovery stage often includes four distinct steps. At the outset, a PPPoE Active Discovery Initiation (PADI) packet may be communicated from a client. The node receiving the PADI packet, may respond with a PPPoE Active Discovery Offer (PADO) packet, after which the client may issue a PPPoE Active Discovery Request (PADR) packet. The discovery stage may conclude with a PPPoE Active Discovery Session-confirmation (PADS) packet.

In some embodiments, a device identifying tag may be included in the PADI packet. For example, in a system in which a router device makes its backhaul available to multiple LAN-side devices, different 0x0103 Host-Uniq tags may be pre-assigned to the LAN-side devices. The TAG_VALUE may include binary data having some value and length. In preferred embodiments, the device identifying tags may be transparent to the network node receiving the PADI packet. The network node may be configured such that the identifying tag is not interpreted and is included, without modification, in responsive packets like a PADO packet and/or a PADS packet.

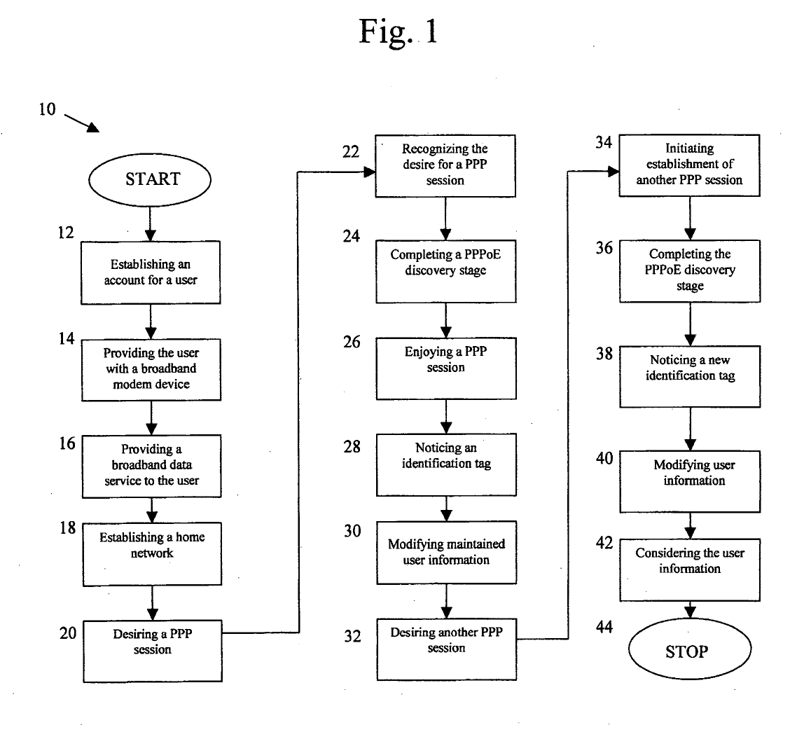

Using an identification tag in accordance with the teachings disclosed herein may be better understood by reference to the Figures. As mentioned above, FIG. 1 presents a flow diagram for a process 10 that facilitates identification of Local Area Network (LAN) side devices using a Point to Point Protocol in accordance with the teachings of the present disclosure. At step 12, a new user may contact a service provider requesting to become a broadband service subscriber. The service may be a wireline broadband option like Asynchronous Digital Subscriber Line (ADSL), some other form of Digital Subscriber Line technology (xDSL), and/or a cable modem-based offering. The service may also include a fiber-based offering like Fiber to the Home (FTTH) and Passive Optical Networking (PON) and/or a wireless option like wireless local loop (WLL), fixed wireless such as MMDS or LMDS, and/or a satellite-based offering.

Whatever the underlying technology and backhaul, the account may be established at step 12. As such, a network operator or service provider may establish the account and define permissions for the user. The account and permissions may “tell” network components to expect communications from the user and how to treat those communications. At step 14, the subscriber/user may be provided with a modem device, which may be incorporated into a device having wireline, powerline, and/or wireless router-like capabilities. In some embodiments, the device may support the establishment of a home networking LAN. Multiple pieces of Customer Premises Equipment (CPE) may be capable of sharing the broadband connection supported by the modem device. These pieces of CPE may include, for example, home appliances, computers, and Voice over Internet Protocol (VoIP) telephones.

Depending on implementation detail, a provided router may have Network Access Translation (NAT) capabilities. The router may give private IP addresses to the LAN-side devices and “hide” LAN-side devices by keeping the private IP addresses on the LAN-side and by allowing LAN-side devices to share a WAN-side IP address assigned to the router. At step 16, the user may have “plugged in” the modem device and the service provider may begin providing a broadband data service to the user. At step 18, the user may have established a wireless home network with an 802.11 (x) wireless router utilizing the modem device to provide a broadband backhaul to the service provider network. In some embodiments, the modem device and the 802.11 (x) router may be viewed, in combination, as the router.

At step 20, a home networked device may desire a PPP session. For example, the home networked device may be a VoIP telephone, and the user want to place a call. At step 22, the modem device and/or associated router or computing platform may recognize this desire and may begin the process of establishing a PPPoE session on behalf of the VoIP telephone. In practice, the process may involve the sending of a PADI packet including a tag identifying the VoIP telephone station as the “true” requesting device.

At step 24, a network access concentrator may recognize that the modem device is seeking to establish a Point to Point session. The access concentrator may be, for example, a digital subscriber line access multiplexer (DSLAM), some other telephone network node, a cable modem termination system (CMTS), some other piece of cable head end equipment, some other cable network node, and/or some other component capable of supporting communication with the modem device. Whatever its form, the access concentrator may “know” that the modem device desires a session, because the modem device issued a request for connection. As mentioned above, this request for connection may include, for example, a PPPoE Active Discovery Initiation (PADI) packet.

In practice, the network node receiving the PADI packet may “think” the request is being made on behalf of the modem device. The network node may not “know” the request is being made on behalf of the user's VoIP telephone station. In an embodiment utilizing a 0x0103 Host-Uniq TAG, the PADI packet may actually contain information identifying the telephone station. The network node, however, may be designed to ignore the tag and merely to include it, unmodified, in a responsive PADO packet as a part of completing the discovery stage at step 24. The VoIP telephone may then, at step 26, enjoy a PPP session, and the user may engage in a telephone call.

While the receiving network node may ignore the identifying tag, other network nodes may not. For example, a combination of network nodes including a Network Access Server (NAS), a Broadband Remote Access Server (BRAS), and/or an attached Database server may take notice of the identification tag at step 28 and modify a repository at step 30 that maintains information about the user. As mentioned above, process 10 may be facilitated by a Point to Point Protocol over Ethernet (PPPoE) client executing at or connection with the modem device. In practice, a PPPoE client may be executing on the modem device and/or a computing platform communicatively coupled to the modem device. The PPPoE client and/or modem device may output a PADI packet on behalf of a LAN-side node. The PPPoE client may pass additional information as well like a UserID/Password combination communicated to a network access server (NAS), which may utilize a security server, such as a RADIUS server, to authenticate the user and authorize the requested access.

In a system like the one depicted in FIG. 2, the modem device may be supporting more than one LAN-side device. As such, at step 32 a different home networked device may desire its own PPP session. For example, a home networked computer may want to connect to a Public Internet resource using a PPPoE session. At step 34, this desire may be recognized and the process of establishing a PPPoE session on behalf of the computer may begin. As mentioned above, the process may involve the sending of a PADI packet including a different tag identifying the computer as the “true” requesting device.

Again, the network node receiving the computer-related PADI packet may “think” the request is being made on behalf of the modem device. As before, the network node may not “know” the request is being made on behalf of the user's computer. In the embodiment utilizing a Host-Uniq TAG, the computer-related PADI packet may contain information identifying the computer. This information may be included in a responsive PADO packet as a part of completing the discovery stage at step 36.

At step 38, some network asset may notice the “new” identification tag and at step 40 may modify the repository maintaining information about the user. As such, the user information may indicate that the user has both a VoIP telephone and a computer utilizing the broadband backhaul. Though a given network node may not know a request is being made on behalf of a “hidden” LAN-side device, in some embodiments, the given node and/or the service provider may “know” a request is coming from the user by referencing some identifying characteristic of the broadband link like modem device MAC address, userID/password combination, a unique circuit identification number for an xDSL line, a virtual path/virtual circuit identification associated with xDSL routing, and/or some other information capable of uniquely identifying the user.

Once the user is “known” by the network, user information may be accessed and modified to help ensure that the service provider knows what types of devices and/or data services the user needs and/or utilizes. For example, at step 42 a service provider may consider the information stored in the repository to determine, for example, how to properly service, market to, bill, and/or support a user. A service provider may, for example, elect to provide a broadband service to a subscriber and to price the service based on a number and/or a type of subscriber device utilizing the broadband service. With such a practice, a provider may consider the information stored in the repository, may generate an invoice at least partially based on the information, and may submit the invoice to the user.

In practice, process 10 may continue, may loop, and/or proceed to stop at step 44. Individual steps of process 10 may be amended, re-ordered, added, and/or deleted without departing from the teachings. In addition, the party or device performing various steps may be altered as well to make effective use of available resources within a system implementing some or all of process 10.

As mentioned above, FIG. 2 shows one embodiment of a distributed system that incorporates teachings of the present disclosure to identify and support LAN-side devices. In operation, end users may seek access through a service provider network 48 to an information network 50, like the Public Internet, an Intranet, an Extranet, some other communication network, and/or some combination thereof. As shown, system 46 includes several premises 52, 54, and 56, each having its own broadband modem/router 58, 60, and 62, respectively.

In practice, various pieces of CPE located at premises 52 may have access to a broadband backhaul provided via modem 58. The modem may be capable of communicatively coupling to service provider network 48. Network 48 may include, for example, a Public Switched Telephone Network (PSTN), a cable network, some xDSL infrastructure, a wireless network, and/or some other networking components capable of facilitating data communication. Whatever its make up, network 48 may be capable of communicating information. The communication could occur, for example, across dedicated circuits, as IP packets, and/or across an air interface.

As depicted, modem 58 may communicate with and/or through a facility 64 of network 48. Facility 64 may be, for example, a remote terminal (RT) site, a central office, a cable head end, or some other provider facility. As such, facility 64 may include network nodes like access concentrator 66, which may include a DSLAM or a CMTS for example. In operation, a device at premises 52 may connect to access concentrator 66 and seek access to an information service server like unified messaging server 68, which may have an associated repository 70 maintaining email, voice mail, facsimile, and other messages for the user living at premises 52. Similarly, a device within premises 52 may utilize modem 58 to place a VoIP telephone call to a call center 72.

In operation, a LAN-side device like computer 74 may indicate a desire to access Public Internet 50. Modem 58 may recognize this desire and may utilize a PPPoE client to begin the process of establishing a PPP session on behalf of computer 74. Modem 58 may support a NAT like feature, which may “hide” the identity of the requesting device. However, in a system incorporating teachings disclosed herein, modem 58 may include a unique identification tag in a PADI packet communicated to access concentrator 66. The identification tag may comply, for example, with a 0x0103 Host-Uniq TAG construct described in IETF RFC2516, which is hereby incorporated by reference.

In some embodiments, information contained in an identification tag may be pre-assigned and may include sixteen bits of information capable, in a standard binary numbering system, to represent device numbers from 0 to 65,536. In a typical home networking environment, it may be unnecessary to identify over 65,000 devices. As such, available device numbers may be broken into categories. For example, 0 to 500 may represent computers, 501 to 1000 may represent broadcast video devices, 1001 to 1500 may represent appliances, 1501 to 2000 may represent telephone stations, 2001 to 2500 may represent home monitoring services, some portion may be set aside for later assignment, etc. In addition, different portions of the numbering system may be assigned to different LAN-side connection technologies. Some blocks may be assigned to 802.11 (x) type connections, while other blocks may be assigned to premises wiring type connections.

Whatever the format of the tag and the information contained in the tag, a network server 76 may “see” the tag and determine that a computer is using the premise 52 backhaul. Server 76 may recognize the computer as a new LAN-side device or determine that it was already aware of the computer. If computer 74 is a “new” device, server 76 may initiate an updating of subscriber information maintained in a repository 78, which may be remote from facility 64 (as shown) or local.

Depending on implementation detail, access concentrator 66 may have a computing platform and an interface that facilitates the communicative coupling of modems 58, 60, and 62 to the computing platform. Access concentrator 66 may also include a second interface that facilitates an outputting of a collection of information representing packets received, for example, from computer 74 and VoIP telephone 80. A Local Area Network (LAN) engine associated, for example, with access concentrator 66 and/or server 76 may be configured to recognize identification tag information included in PPPoE discovery stage packets. The identification tag information may identify VoIP telephone 80 and computer 74 as the subscriber LAN devices utilizing the backhaul of premises 52.

In some embodiments, the LAN engine may be at least partially embodied by a processor accessing a computer-readable medium having computer-readable instructions and executing the computer-readable instructions to recognize an existence of the tag, to identify device identification information contained in the tag, and to update a memory associated with a Broadband Remote Access Server to acknowledge the device identification information.

As indicated above, communication between modem 58 and a node of a WAN network may take several forms. Communication may occur across dedicated circuits, in a packetized manner, across virtual connections, in a special data frequency band, across a wireline connection including copper, optical fiber, coaxial fiber, an air interface, and/or a combination thereof. Similarly, communication between modem 58 and computer 74 or telephone 80 may take several forms. There may be a physical link of copper, coax, fiber, etc. There may also be an air interface that utilizes Radio Frequency (RF) communication. As such, devices like computer 74 and modem 58 may be capable of Radio Frequency communication with one another and with other nodes via a Wireless LAN using a short-range or local wireless technology like 802.11, Wi-Fi, Bluetooth, and/or some other technique.

It should be understood that the mechanisms, computers, devices, engines, servers, and/or platforms, described herein, may take several different forms and may be stand alone and/or incorporated into several different pieces of equipment, like laptop computers, desktop computers, telephones, mainframes, PSTN switches, Ethernet switches, routers, gateways, hardware, firmware, software, work stations, other options having some level of computing capability, and/or a combination thereof. For example, various engines could be independent applications, could be independent servers, could be executing on different platforms, and/or could be executing on a single platform.

The methods and systems described herein provide for an adaptable implementation. Although certain embodiments have been described using specific examples, it will be apparent to those skilled in the art that the invention is not limited to these few examples. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A method of identifying a device comprising:
receiving a request to establish a Point to Point Protocol over Ethernet (PPPoE) session on behalf of a Local Area Network (LAN) side device;
outputting a PPPoE discovery stage packet that comprises a tag identifying the LAN side device;
receiving a different request to establish a different PPPoE session on behalf of a different LAN side device; and
outputting a different PPPoE discovery stage packet that comprises a different tag identifying the different LAN side device.

2. The method of claim 1, wherein the PPPoE discovery stage packet comprises a PPPoE Active Discovery Initiation packet.

3. The method of claim 1, further comprising maintaining information associating the LAN side device with the tag and the different LAN side device with the different tag.

4. The method of claim 1, further comprising receiving an access concentrator packet responsive to the PPPoE discovery stage packet, the access concentrator packet comprising the tag.

5. The method of claim 4, further comprising:
recognizing the tag in the access concentrator packet; and
communicating the access concentrator tag to the LAN side device.

6. The method of claim 4, wherein the access concentrator packet comprises a PPPoE Active Discovery Offer packet and comprises the tag in an unmodified form.

7. The method of claim 1, wherein the tag complies with a Host-Uniq TAG construct described in IETF RFC 2516.

8. The method of claim 1, further comprising utilizing a PPPoE client executing at a node at least partially interconnecting a LAN to a wide area network node to generate the PPPoE discovery stage packet.

9. The method of claim 1, further comprising:
enabling a Point to Point Protocol (PPP) session for the LAN side device; and
enabling a different Point to Point Protocol (PPP) session for the different LAN side device.

10. The method of claim 9, further comprising disabling a Network Address Translation feature in connection with the PPP session.

11. The method of claim 1, further comprising receiving the request via a connection type selected from the group consisting of an Ethernet link, an 802.11 (x) link, a Bluetooth link, a Universal Serial Bus link, and a powerline networking link.

12. The method of claim 1, further comprising utilizing a modem device to output the PPPoE discovery stage packet, wherein the modem device is selected from the group consisting of an xDSL modem, a cable modem, a fixed wireless modem, and a satellite modem.

13. The method of claim 1, further comprising:
utilizing a modem device to output the PPPoE discovery stage packet and the different PPPoE discovery stage packet; and
communicatively coupling the modem device and a plurality of other modem devices to an access concentrator node of a wide area network.

14. A device identification system, comprising:
an access concentrator having a computing platform and an interface operable to facilitate a communicative coupling of a plurality of remote devices to the computing platform;
a second interface communicatively coupled to the computing platform and operable to facilitate an outputting of a collection of information representing a PPP session of a first of the plurality of remote devices and a different PPP session of a different one of the plurality of remote devices; and
a Local Area Network (LAN) engine communicatively coupled to the interface and configured to recognize an identification tag in a packet included in a discovery stage of the PPP session, the identification tag identifying a subscriber LAN device communicating the packet via the first of the plurality of remote devices.

15. The system of claim 14, wherein the tag complies with a Host-Uniq TAG construct described in IETF RFC 2516.

16. The system of claim 15, wherein the LAN engine is at least partially embodied by a processor accessing a computer-readable medium having computer-readable instructions and executing the computer-readable instructions to recognize an existence of the tag, to identify device identification information contained in the tag, and to update a memory associated with a Broadband Remote Access Server to acknowledge the device identification information.

17. The system of claim 14, further comprising the first of the plurality of remote devices, wherein the first of the plurality of remote devices comprises an xDSL modem.

18. The system of claim 14, wherein the access concentrator comprises a cable modem termination system.

19. The system of claim 14, wherein the access concentrator comprises a digital subscriber line access multiplexer.

20. The system of claim 14, further comprising a Broadband Remote Access Server communicatively coupled to the LAN engine and operable to maintain information representing the subscriber LAN device.

21. A method of identifying remote devices, comprising:
receiving a PPPoE packet from a remote node;
recognizing that the PPPoE packet comprises a tag including information associated with a device communicating via the remote node;
receiving another PPPoE packet from the remote node; and
recognizing that the other PPPoE packet comprises a different tag including other information associated with a different device communicating via the remote node.

22. The method of claim 21, further comprising:
associating the remote node with a subscriber; and
maintaining subscriber information comprising an identification of the device and the different device.

23. The method of claim 21, further comprising providing a broadband link at least partially interconnecting a communication network node and the remote node.

24. The method of claim 21, wherein the PPPoE packet comprises a PPPoE Active Discovery Initiation (PADI) packet.

25. The method of claim 21, further comprising:
providing a broadband link at least partially interconnecting a communication network node and the remote node;
associating the remote node with a subscriber;
maintaining subscriber information comprising an identification of the device and the different device; and
altering a cost of using the broadband link in response to recognizing an additional device communicating with the communication network node via the remote node.

26. The method of claim 21, further comprising:
providing a broadband link at least partially interconnecting a communication network node and the remote node;
associating the remote node with a subscriber;
maintaining subscriber information comprising an identification of the device and the different device; and
considering the subscriber information in connection with generating a marketing offer presentable to the subscriber.

27. The method of claim 21, further comprising:
providing a broadband link at least partially interconnecting a communication network node and the remote node;
associating the remote node with a subscriber;
maintaining subscriber information comprising an identification of the device and the different device; and
considering the subscriber information in connection with making a communication network planning decision.

28. The method of claim 21, further comprising:
providing a broadband link at least partially interconnecting a communication network node and the remote node;
associating the remote node with a subscriber;
maintaining subscriber information comprising an identification of the device and the different device;
receiving a trouble-shooting request from the subscriber; and
considering the subscriber information in connection with offering a suggestion responsive to the trouble-shooting request.

29. The method of claim 21, wherein the communication network node comprises a Broadband Remote Access Server.

30. The method of claim 21, wherein the device is selected from a group consisting of a computer, a wireless access point, a Universal Serial Bus device, a Voice over Internet Protocol telephone, a television, a Set Top Box, a refrigerator, a washing machine, and a home networking device.

31. The method of claim 21, wherein the tag comprises a sixteen bit tag.

32. The method of claim 21, wherein the tag complies with a Host-Uniq TAG construct described in IETF RFC 2516.
